(19) United States
(12) Patent Application Publication
(10) Pub. No.: US 2005/0065846 A1
(43) Pub. Date: Mar. 24, 2005

(54) Methods and system for marketing and rewards

(76) Inventor: Paul H. Burger, Glendale, CA (US)

Correspondence Address: CISLO & THOMAS, LLP, 233 WILSHIRE BLVD, SUITE 900, SANTA MONICA, CA, 90401-1211, US

(21) Appl. No.: 10/950,296

(22) Filed: Sep. 24, 2004

Related U.S. Application Data
(60) Provisional application No. 60/505,598, filed on Sep. 24, 2003.

(51) Int. Cl. G06F 17/60

(52) U.S. Cl. 705/14

(57) ABSTRACT

Exemplary embodiments of the present invention may include a system and method for offering discounts to consumers from lenders, realtors, and from other regional or Internet businesses to induce a consumer to use the services of a particular lender, realtor, or other business.

### CROSS-REFERENCE TO RELATED APPLICATIONS

This application claims the benefit of U.S. Provisional Patent Application No. 60/505,598, filed on Sep. 24, 2003, which is hereby incorporated by reference for all purposes.

### BACKGROUND

Buying a home, refinancing, and home improvement may be times in which a person spends the most money in a short period of time in their lifetime. The largest expense to homebuyers and sellers, and refinancing may be the realtor fees and mortgage origination costs, among others. Many companies and brokers offer services that may include real estate and mortgage services. What is needed is a system and method to offer homebuyers, sellers and refinancers discounts from regional businesses to entice them to use the corresponding services, and possibly discounts and incentives on the realtor fees, mortgage origination fees, title and escrow fees.

When people move into a new city or area, they may have to find a new doctor, dentist, grocery store, cleaners, etc. It may be advantageous to offer savings by other businesses via a group arrangement to influence them to utilize a particular lender, realtor or other businesses. More people may use the service of a lender, realtor, or other business if they were offered discounts and/or other incentives on fees from the lender, realtor, or other business, and/or discounts from regional businesses.

### SUMMARY

Exemplary embodiments of the present invention may include a system and method for offering discounts to consumers from lenders, realtors, and from other regional businesses to influence the consumer to use the services of a particular lender, realtor, or other business.

### BRIEF DESCRIPTION OF THE DRAWINGS

FIG. 1 is a block diagram of a method for setting up a team according to an exemplary embodiment.

FIG. 2 is a block diagram of a method of a transaction according to an exemplary embodiment.

### DETAILED DESCRIPTION

The detailed description set forth below in connection with the appended drawings are intended as a description of exemplary embodiments and are not intended to represent the only forms in which the embodiments may be constructed and/or utilized. The description also sets forth the functions and the sequence of steps for constructing and operating the exemplary embodiments in connection with the illustrated embodiments. However, it is to be understood that the same or equivalent functions and sequences may be accomplished by different embodiments that are also intended to be encompassed within the spirit and scope of this disclosure.

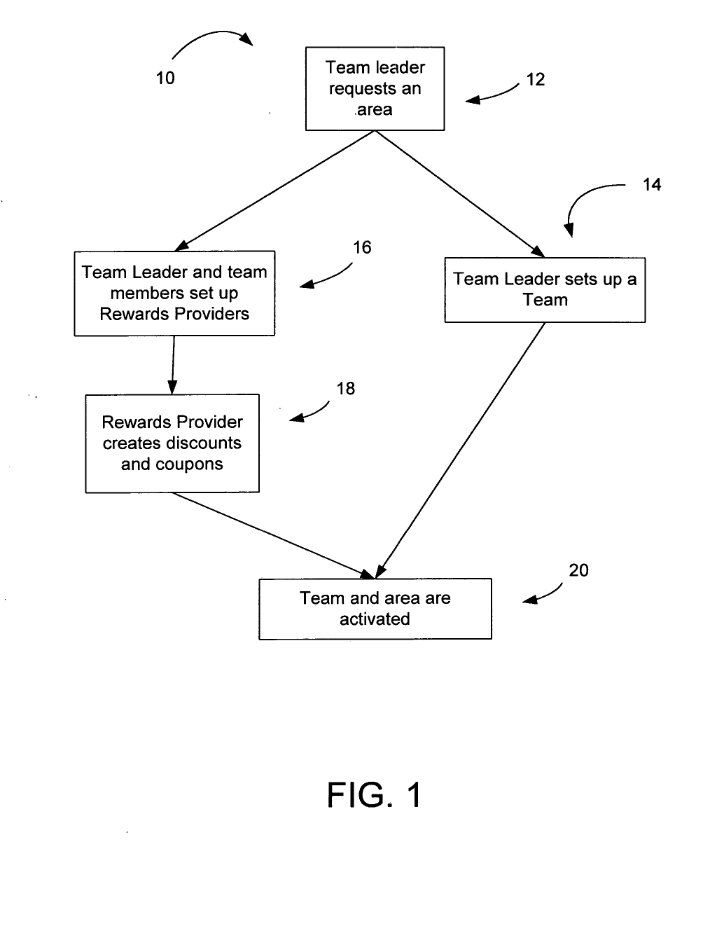

A method of setting up and acquiring a team area according to one exemplary embodiment is shown in FIG. 1, generally at 10. Method 10 may include a team leader requesting an area, at 12. The team leader may be a lender, or other person, as desired. Method 10 also may include the team leader setting up a team of real estate professionals, at 14. The team leader may enlist the services of professionals that typically provide services during a real estate purchase, refinancing, or other related transactions. The team leader may utilize the services of a title company, escrow company, real estate agents, attorneys, insurance agents, appraisers, pest inspectors, notaries, and home inspectors, among others, and the like. The team leader may include more than one team member in each of those categories such that when many transactions are to take place, many different title companies, etc. may be utilized such that the transactions are completed quickly and efficiently.

Method 10 also may include the team leader and the team members setting up rewards providers, at 16. Rewards providers may be regional businesses that may offer discounts or other incentives to the customers that utilize this service. Rewards providers may be cleaners in the area, as well as eating establishments, hardware stores, and many other businesses, and the like. The rewards providers may create their discounts and coupons online using the system and may setup many different discounts and coupons, and activate only certain ones during certain periods, such that they may control what discounts may be utilized, as desired.

Once the team leader has set up a core team of real estate professionals and enlisted the discounts from rewards providers such that the discounts are combined to be in excess of a predetermined dollar amount for the area required by the system, at 18 the team may be activated for the area, at 20. The predetermined amount may correspond to the average household income of the owner occupied residences that comprise the team leader's area.

The team leader may be the only team leader in the area such that no other team leaders may utilize the same geographic area. In this manner, a team leader may be granted an exclusive area such that the system and method may be utilized to entice and encourage customers to use a specific team based upon the discounts, etc.

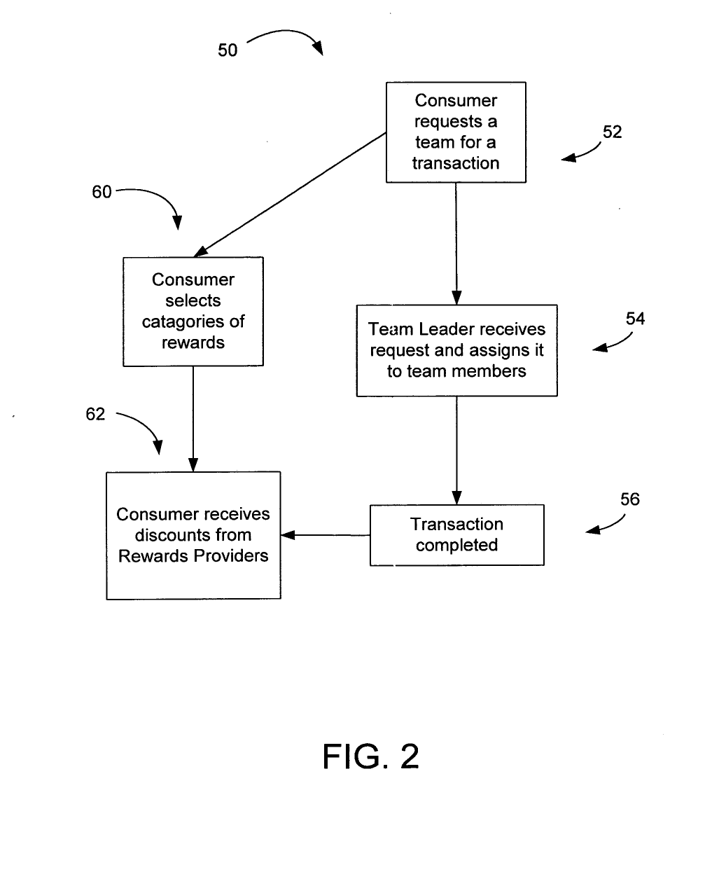

FIG. 2 is a transaction method according to an exemplary embodiment, generally at 50. Method 50 may include the customer requesting a team for a transaction, at 52. The consumer may go online to a website to facilitate this, however, it will be appreciated that other avenues may be utilized to accomplish this activity. After the consumer requests a team for a transaction at 52, the team leader may receive the request for the services requested by the customer. Typically, this may occur via e-mail or other methods, as desired. The team leader receives the request and assigns different team members to that request based upon the particular transaction requested by the customer.

Method 50 also may include the transaction being completed at 56. This may be when the mortgage closes, when the refinance is funded, or other transaction-ending event. Once the transaction is completed, some and/or all of the transaction team members who participated in the successful transaction may pay a relatively small fee to the system provider. Alternatively, the provider of the system may also charge some and/or all team leaders and transaction team members a fixed monthly or yearly fee to utilize the system, as desired.

Method 50 may include the consumer selecting categories for the discounts that they are interested in, at 60. The consumer may select general areas of discounts they may be interested in, in their regional area. These general areas may include, but not be limited to, home improvement, dining, cleaners, lawn care, dentists, health care, hair styling, and the like. The consumer may then be informed about the amount of discounts available for each of these categories, selected by the consumer when the consumer initially requested services, such that a consumer may be more likely to utilize the services of the team rather than assembling their own group of professionals for a particular transaction.

Once the consumer has selected the categories and the transaction is completed, the consumer may receive the discounts from the rewards providers, at 62. This may be accomplished with a code via the Internet automatically, however, other methods and configurations may be utilized, as desired. The consumer may know from which rewards providers the discounts will come, but may not know the details of the discount or incentive until the transaction closes. This may protect the rewards provider from pricing conflicts with their regular retail clients.

Discounts and incentives provided by each rewards provider may vary from time to time, as determined by the rewards provider as long as the total amount offered remains above a predetermined amount for a particular team area. It may be important that the rewards providers provide a discount or incentive that they do not offer to the general public, such that a consumer may be more likely to utilize the services of the team rather than assembling their own group of professionals for the real estate, or other transaction.

Furthermore, when the consumer redeems the coupon through the system, the reward coupon, with the consumer information and a date and time stamp, may be embedded in the coupon and sent to the rewards provider, such that the rewards provider will be informed that a particular coupon has been activated, and by whom. This may decrease the likelihood of fraudulent coupons and help the rewards provider better track their advertising and promotions.

In this manner, the rewards providers may benefit with increased business, the team members may benefit by increased business and increased business leads, and a small fee may only be paid to the system provider once the transaction closes and/or on a fixed fee basis. This fee may be paid by the lender and/or realtor such that there is little or no cost to the other transaction team members or rewards providers. However, others may pay a fee, as desired.

With this system and method, team members and team leaders may be more likely to utilize the system as it may be of minimal or no cost until after they have made money, or the fixed fee charged may be relatively small in comparison to the amount of business that the system may attract.

Similarly, rewards providers may manage their own coupons, discounts, and advertising themselves, thereby saving money. Furthermore, the rewards providers may make up their own printable coupons utilizing the system thereby saving printing and design costs. The consumer may save money on discounts from the transaction team, as well as the discounts from the rewards providers. Therefore, with this system everyone involved is more likely to utilize the system and team to increase business and revenue and business leads. Everyone involved may make money, which may make everyone relatively more satisfied.

Rewards providers may be regional to the area in which the team leader has been granted. However, rewards providers that have a strong Internet or other presence in the area may also be considered. Furthermore, rewards providers may provide discounts to other team leaders in nearby areas who may also be able to utilize the rewards providers from other areas, as desired, if the rewards providers so desire. In this manner, the rewards provider may be able to increase business by having more consumers utilize their business, or services. This system will also enable team leaders to generate their own business leads in a new way such that they may not be dependant upon real estate agents, realtors, and the like, for business contacts and/or leads. Furthermore, the team members need not pay any money until the transaction closes, and may also offer discounts on their services for the transaction. Therefore, the team members may also enter a team while spending little or no money until the transaction closes, which may entice them to join teams more readily.

The system provider may provide the system and method for the teams and rewards providers to better conduct business. The team leader, team members, and rewards providers may not need pay any up front costs, have no capital expenditures, and need no new equipment to utilize the system. The system may already be in place for team members to utilize, for a small fee per completed transaction and/or fixed fee basis.

The categories for rewards providers may include sports, entertainment, and leisure, kids and family, food and beverage, computers and electronics, apparel and fashion, home and garden, gifts and flowers, books and music, office and business, new cars and trucks, health and beauty, among others, as desired. The consumer may select more categories if more team services are utilized, such as loan, real estate selling, real estate buying, appraisal, inspection, termite inspection, title, escrow, etc. The number of mortgage and real estate services used by the customer may increase the amount of rewards categories and total rewards available to the customer.

With this system and method, there are no detriments to joining a team or becoming a rewards provider and many benefits may be actualized, including increased business, increased business contacts and or leads, and reduced advertising expenses, among others. Other advantages may include that the rewards provider will be notified when a transaction has ended such that the rewards provider may know what coupons or discounts to expect.

Another advantage may be that customers may retrieve their rewards online and instantaneously thereby saving time and money. Furthermore, the team members may be able to utilize the system to print out flyers, to recruit rewards providers and induce customers, utilizing the system. Furthermore, rewards providers may be invited by nearby teams to offer discounts and incentives for the inviting team. There also may be aspects of the system that allow team leaders to obtain information about current rewards providers for nearby teams. Since teams do not compete with each other, the team leader may invite a rewards provider to offer discounts in the inviting team leader's area.

With the flyers the team leader may identify the team members or rewards providers that generated the lead. This may be valuable information for the team leader.

With this system, the team leader may control the flow of each customer lead, and designate which of the team members will work on it. Demographic data may dictate the dollar requirement and number of rewards providers needed in each particular area, such that areas with a high median income household may be required to have more rewards provided than an area with a low median household income. Other advantages may include that the team areas have a consistency based on various demographic information. This may keep the utility of each team uniform throughout the country. Furthermore, the consistency of using the same team members and rewards providers may encourage and develop better business relationships.

Another advantage may be that teams may be setup one by one by a single individual, the team leader. The team leader is the head of the team throughout its life. Furthermore, the team leader may sell an area once it has been established, such that the business development in the area may become valuable and may be sold.

The system may include all hardware and software for gathering consumer information, notifying the team leader and team members. Further it may include all hardware and software for the rewards provider to create and activate discounts and coupons. The system may include a server and other computers linked via a network, and programming code to implement the system. The network may be a LAN, WAN, Internet or other network. The programming code may be Java script, HTML, or other code. It will be appreciated that other hardware, software, and types of hardware and software may be utilized, as desired.

It will be appreciated that although this system has been described for a real estate, mortgage, and/or refinancing transaction, this system may be utilized by virtually any business to increase business leads and to further encourage consumers to use the services of a business or group of businesses, as desired.

In closing, it is to be understood that the exemplary embodiments described herein are illustrative of the principles of the exemplary embodiments. Other modifications that may be employed are within the scope of this disclosure. Thus, by way of example, but not of limitation, alternative configurations may be utilized in accordance with the teachings herein. Accordingly, the drawings and description are illustrative and not meant to be a limitation thereof.

1. A system for generating business leads and offering rewards to customers, comprising:
inducing a user to utilize the system;
generating a request for services by a user;
creating rewards for the user;
selecting reward categories by the user;
receiving the request for services by a lender;
assigning the request to one or more real estate team members by the team leader;
completing the services requested by the user; and
authorizing rewards for the user,
wherein said inducing comprises authorizing rewards for the user from the real estate transaction team.

2. A method for creating a system for offering rewards to a real estate consumer or borrower, comprising:
requesting a geographic area by a lender;
setting up a real estate transaction team by the lender;
recruiting reward providers by the real estate transaction team and lender;
creating rewards by the reward provider; and
activating said geographic area when said rewards reach a predetermined threshold.

3. A method for generating business leads and rewarding customers, comprising:
requesting services by a user;
selecting reward categories by the user;
receiving the request for services;
assigning the request for services to team members;
completing the services requested by the user; and
authorizing rewards for the user from the rewards providers.

4. The method of claim 3, further comprising inducing a user to utilize the system.

5. The method of claim 4, wherein said inducing comprises authorizing rewards for the user from the transaction team.

6. The method of claim 3, further comprising creating rewards for the user.

7. The method of claim 4, further comprising authorizing rewards for the user from the transaction team.

8. A system for generating business leads and offering rewards to customers, comprising:
inducing a user to utilize the system;
generating a request for services by a user;
selecting rewards categories by the user;
receiving the request for services by a team leader;
assigning the request to a team member by the team leader;
completing the services requested by the user; and
authorizing rewards for the user.

9. The method of claim 8, further comprising creating rewards for the user.

10. The method of claim 9, wherein said inducing comprises authorizing rewards for the user from the transaction team.

11. The method of claim 8, further comprising authorizing rewards from the transaction team for the user.

12. A method for managing user requests and rewards, comprising:
generating a request for services by a user;
selecting rewards categories by the user;
receiving the request for services by a team leader; and
activating the discounts for the user.

13. The method of claim 12, further comprising creating rewards for the user by a rewards provider.

14. A method for managing user requests and rewards, comprising:
generating a request for services by a user;
creating rewards for the user by a rewards provider;
selecting reward categories by the user;
receiving the request for services by a team leader; and
authorizing the discounts for the user.

15. Computer readable media having instructions stored thereon, which when executed by a computing device, cause the computing device to perform a method comprising the steps of:
generating a request for services by a user;
creating rewards for the user by a rewards provider;
selecting reward categories by the user;
receiving the request for services by a team leader; and
authorizing the discounts for the user.

16. A method for creating a system for offering rewards to a consumer, comprising:
requesting an area by a team leader;
setting up a transaction team by the team leader;
recruiting reward providers by the transaction team and team leader;
creating rewards by the rewards provider; and
activating said area when offered rewards reach a predetermined threshold.

17. The method of claim 16, wherein said area is a geographic area.

18. The method of claim 16, wherein said team leader is a mortgage or refinance lender.

19. The method of claim 16, wherein said transaction team comprises a real estate agent, insurance professional, and a home inspector.

20. The method of claim 16 wherein said rewards provider are businesses desiring to increase sales.

21. A system for generating business leads and offering rewards to customers, comprising:
inducing a user to utilize the system;
generating a request for services by a user;
creating rewards for the user;
selecting reward categories by the user;
receiving the request for services by a team leader;
assigning the request to one or more team members by the team leader;
completing the services requested by the user; and
authorizing rewards for the user,
wherein said inducing comprises authorizing rewards for the user from the transaction team.
